(19) United States
(12) Patent Application Publication
(10) Pub. No.: US 2019/0034336 A1
(43) Pub. Date: Jan. 31, 2019

(54) SYSTEM AND METHOD FOR HARDWARE-INDEPENDENT MEMORY STORAGE

(71) Applicant: Faraday&Future Inc., Gardena, CA (US)

(72) Inventors: Richard Edward SLINDEE, Los Angeles, CA (US); Jana Mahen FERNANDO, Torrance, CA (US); Douglas D. CHIDESTER, Mountain View, CA (US)

(21) Appl. No.: 16/073,335

(22) PCT Filed: Jan. 25, 2017
(86) PCT No.: PCT/US2017/014913

§ 371 Date: Jul. 26, 2018

Related U.S. Application Data
(60) Provisional application No. 62/288,938, filed on Jan. 29, 2016.

(51) Int. Cl. G06F 12/0804; G06F 12/02; G06F 3/06

(52) U.S. Cl. CPC G06F 12/0804; G06F 12/023; G06F 2212/222; G06F 3/0683; G06F 3/0647; G06F 3/0604

(57) ABSTRACT

The embodiments of the present invention relate to a file system, and more particularly, a file system compatible with multiple types of non-volatile memory for safety-critical embedded systems, such as an Electronic Control Unit (ECU) of an automobile. Some examples of the disinitiate file closure include an ECU having RAM and non-volatile system memory managed by a file system.

### CROSS-REFERENCE TO RELATED APPLICATION

This application claims priority to U.S. Provisional Application No. 62/288,938, filed Jan. 29, 2016, which is hereby incorporated by reference in its entirety for all purposes.

### FIELD OF THE DISCLOSURE

The present invention generally relates to an electronic filing system, and more particularly, a file system compatible with multiple types of non-volatile memory for safety-critical embedded systems, such as an Electronic Control Unit (ECU) of an automobile.

### BACKGROUND OF THE DISCLOSURE

Embedded systems can feature random access memory (RAM), non-volatile memory, and other types of memory and storage within a memory hierarchy. RAM can provide fast performance but can require a connected power supply to retain data. Non-volatile memory, however, can retain data when the power supply is disconnected. Examples of non-volatile memory include, but are not limited to, Electrically Erasable Programmable Read-Only Memory (EEPROM), battery-backed RAM, and flash. To create a system that can function quickly and retain data when the power supply is disconnected, data can be stored in non-volatile memory and loaded into RAM when it is needed to execute a function. When RAM data is modified, it can later be saved to non-volatile memory to be available in the event of loss of power. When data is saved to RAM or non-volatile memory, the stored data can be accessed by a function having an address pointer.

Non-volatile memory in many embedded systems can be managed manually within application code or by a file system. When non-volatile memory is managed by application code, developers need to agree on which addresses in non-volatile memory to allocate to each data structure. Managing the address of each structure prevents data from being inadvertently overwritten or lost. Manually allocating and tracking the contents of each level of a memory hierarchy can be error-prone and tedious. File systems, however, can automatically manage memory on multiple levels and provide other features, described below for example, to alleviate several disadvantages of manual memory management.

File systems can allocate space for data in multiple levels of a memory hierarchy within a computer system and maintain a record of where each structure is located. Other features of file systems include, but are not limited to, multi-level directories and the use of security credentials. These file systems are advantageous to computer systems—including, but not limited to, mobile devices, laptops, and other consumer electronics—with many files, high-level functions, and/or sensitive data. Electronic Control Units (ECUs) within consumer automobiles, however, generally run low-level, safety-critical applications. Therefore, many features of contemporary file systems are unnecessary for managing memory within an ECU. Thus, there exists a need in the field of ECUs for a file system tailored to automotive control sequences and ECU hardware, which can vary across ECUs incorporated into a single automobile.

### SUMMARY OF THE DISCLOSURE

Embodiments of the present invention relate to a file system and the use of the same. More particularly, the embodiments of the present invention are directed to a file system compatible with multiple types of non-volatile memory for safety-critical embedded systems, such as an Electronic Control Unit (ECU) of an automobile. Some examples of the disclosure include an ECU having RAM and non-volatile memory managed by a file system. Contemporary file systems can be designed to work with specific hardware implementations of non-volatile memory such as for example EEPROM, flash, battery-backed RAM, or other types of non-volatile memory. In some examples of ECUs, the hardware used for non-volatile memory may be unknown at the start of software development or may be inconsistent between ECUs incorporated into a line of vehicles or even within a single vehicle, for example. This inconsistency can make it difficult for a team of developers to select a file system for an ECU and make it even more difficult to manually manage the non-volatile memory within function code. Furthermore, some examples of file systems can dynamically allocate memory. In safety-critical systems such as an ECU, it can be advantageous to save data only when there is sufficient time to complete the save operation to avoid loss of critical information, for example. In some examples, an ECU can include a hardware-independent file system designed for safety-critical systems.

In some examples, an ECU can use a file system to manage RAM and non-volatile memory. In some examples, a file system can provide software developers with hardware-independent functions for using the file system in code to be executed by the ECU. A hardware-independent file system according to examples of the disclosure can provide a layer of abstraction so developers do not need to tailor their code to the type of non-volatile memory the ECU uses. According to some examples of the disclosure, the file system can include a table of contents having an array of entries. The array of entries can record and track one or more data structures that may be stored in RAM and/or non-volatile memory of an ECU, for example. The array can include for each entry a unique ID, its address in RAM and non-volatile memory, its size, and metadata. The metadata can include, for example, a version number, a time the entry was last saved to non-volatile memory, and other information according to examples of the disclosure. When the ECU is powered on, the table of contents can be loaded from non-volatile memory into RAM. Before powering off, the ECU can save the table of contents to non-volatile memory when it is safe to do so. In some examples, data can be saved to non-volatile memory in situations where there is enough time to complete the process of saving without interruption to prevent data corruption, making the ECU more reliable.

### BRIEF DESCRIPTION OF THE DRAWINGS

FIG. 1 illustrates an exemplary memory hierarchy according to examples of the disclosure.

FIG. 2 illustrates a block diagram of an exemplary ECU including RAM and non-volatile memory, each with data stored thereon, according to examples of the disclosure.

FIG. 3 illustrates an exemplary process for initiating a file system and loading or generating a table of contents for the file system, according to examples of the disclosure.

FIG. 4 illustrates an exemplary process for managing a data structure including registering an entry, saving an entry, and retrieving an entry using a file system, according to examples of the disclosure.

FIG. 5 illustrates an exemplary process for saving all entries and the table of contents to non-volatile storage using a file system, according to examples of the disclosure.

FIG. 6 illustrates a block diagram of an exemplary vehicle incorporating multiple ECUs, according to examples of the disclosure.

### DETAILED DESCRIPTION

In the following description, reference is made to the accompanying drawings which form a part hereof, and in which it is shown by way of illustration specific examples that can be practiced. It is to be understood that other examples can be used and structural changes can be made without departing from the scope of the examples of the disclosure.

This relates to a file system, and more particularly, a file system compatible with multiple types of non-volatile memory for safety-critical embedded systems, such as an Electronic Control Unit (ECU) of an automobile. Some examples of the disclosure include an ECU having RAM and non-volatile memory managed by a file system. Contemporary file systems can be designed to work with specific hardware implementations of non-volatile memory such as for example EEPROM, flash, battery-backed RAM, or other types of non-volatile memory. In some examples of ECUs, the hardware used for non-volatile memory may be unknown at the start of software development or may be inconsistent between ECUs incorporated into a line of vehicles or even within a single vehicle, for example. This inconsistency can make it difficult for a team of developers to select a file system for an ECU and make it even more difficult to manually manage the non-volatile memory within function code. Furthermore, some examples of file systems can dynamically allocate memory. In safety-critical systems such as an ECU, it can be advantageous to only save data when there is sufficient time to complete the save operation to avoid loss of critical information, for example. In some examples, an ECU can include a hardware-independent file system designed for safety-critical systems.

In some examples, an ECU can use a file system to manage RAM and non-volatile memory. In some examples, a file system can provide software developers with hardware-independent functions for using the file system in code to be executed by the ECU. A hardware-independent file system according to examples of the disclosure can provide a layer of abstraction so developers do not need to tailor their code to the type of non-volatile memory the ECU uses. According to some examples of the disclosure, the file system can include a table of contents having an array of entries. The array of entries can record and track one or more data structures that may be stored in RAM and/or non-volatile memory of an ECU, for example. The array can include for each entry a unique ID, its address in RAM and non-volatile memory, its size, and metadata. The metadata can include, for example, a version number, a time the entry was last saved to non-volatile memory, and other information according to examples of the disclosure. When the ECU is powered on, the table of contents can be loaded from non-volatile memory into RAM. Before powering off, the ECU can save the table of contents to non-volatile memory when it is safe to do so. In some examples, data can be saved to non-volatile memory in situations where there is enough time to complete the process of saving without interruption to prevent data corruption, making the ECU more reliable.

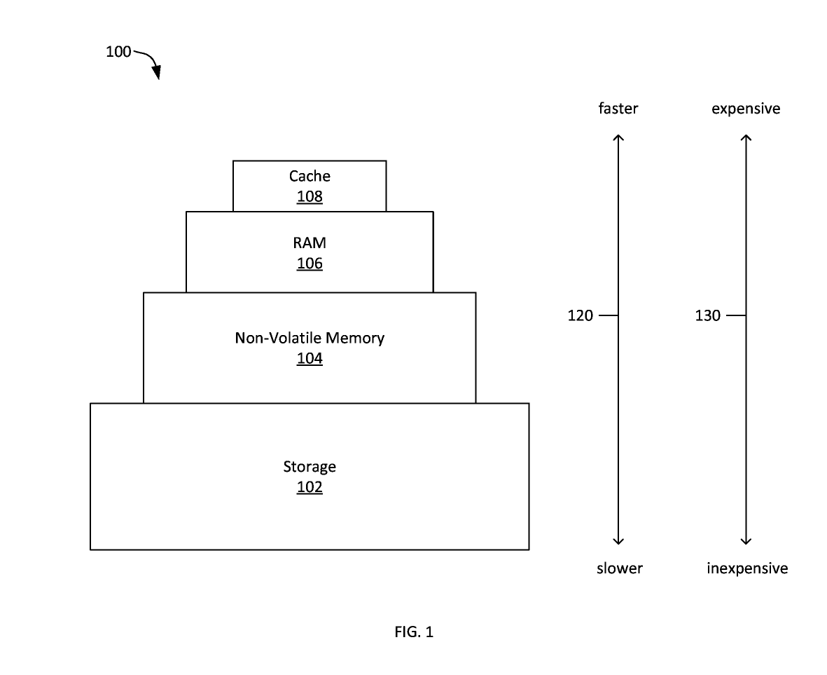

File systems can be used in computing systems such as embedded systems, consumer electronics, and computers to manage data stored thereon, according to examples of the disclosure. A computing system can include multiple levels of memory, such as volatile memory (e.g., random access memory (RAM)) and non-volatile memory, for example. Each level can have tradeoffs associated therewith. FIG. 1 illustrates a memory hierarchy 100 according to examples of the disclosure. The memory hierarchy 100 can include multiple levels of memory with associated tradeoffs such as speed 120 and cost 130, for example. In some examples, the memory hierarchy 100 includes storage 102, non-volatile memory 104, RAM 106, and a cache 108. Storage 102 can be implemented in a hard drive, for example. Non-volatile memory 104 can be implemented in an EEPROM, battery-backed RAM, or flash, for example. Other implementations of storage 102 and non-volatile memory 106 are possible. Other exemplary computer systems may have more or fewer levels within a memory hierarchy as appropriate for the computer system. Some ECUs can have a memory hierarchy including RAM and non-volatile memory, for example.

In the example of FIG. 1, the cache 108 is the fastest and most expensive level of memory in the hierarchy 100 and storage 102 is the slowest and least expensive. As such, an exemplary computer system having example memory hierarchy 100 can have the least amount of space in the cache 108 and the most amount of space in storage 102, for example. By having less space in faster, expensive memory and more space in slower, inexpensive memory; a system can perform at high speeds when necessary without including excessively large amounts of expensive, high-speed memory.

Furthermore, in some examples, volatile levels of the memory hierarchy, such as the cache 108 and RAM 106 only retain data while a system power supply is connected. Other levels of the memory hierarchy 100, such as non-volatile memory 104 and storage 102 can retain data while a system power supply is disconnected. Therefore, having multiple levels of memory can, for example, allow a computer system to retain data when powered off in addition to the other tradeoffs discussed above.

To make effective use of its memory hierarchy, a computer system may move data between hierarchy levels during operation, for example. In some examples, when a computer system is executing an application or modifying a file, it can be advantageous for that data to reside on high-speed, high-cost memory such as the cache 108. When the computer has finished modifying data, the data can be saved to a slower, less expensive level of memory, such as non-volatile memory 104 or storage 102, for example. In some examples, saving data not currently in use to non-volatile memory 104 or storage 102 can make room in the cache 108 and in RAM 106 for other data and can secure it in the event of a power outage. For simple memory hierarchies, such as those including only RAM and non-volatile memory, for example, developers can manually track which addresses in each level of memory a data structure is to be saved. Keeping a record of where each data structure can be saved in each level of memory can help a team of developers avoid inadvertently overwriting or losing track of data, for example.

In some examples, as memory hierarchies become more complex, as developer teams grow, or as development moves at faster speeds, manually tracking the location of each data structure can become error-prone and tedious. Furthermore, to manually manage non-volatile memory, developers must understand which hardware the computer system will use and how to manage its memory, for example. Therefore, many computer systems include a file system to manage memory at multiple levels, for example. In some examples, file systems can allocate space in multiple levels of a memory hierarchy within a system and maintain a record of where each structure is located. Other features of file systems include, but are not limited to, multi-level directories and the use of security credentials. These file systems are advantageous to systems with many files, high-level functions, and/or sensitive data, for example. In some examples, file systems are designed to work with a particular type of hardware for each level of memory.

Electronic Control Units (ECUs) within consumer automobiles, however, generally run low-level, safety-critical applications, for example. Therefore, according to some examples of the disclosure, many features of contemporary file systems may be unnecessary for managing memory within an ECU. Furthermore, in some examples, contemporary file systems can be hardware-dependent. When, for example, the hardware implementation of non-volatile memory can vary from project-to-project or is not agreed on at the start of a project, memory management can be challenging for developers because different types of non-volatile memory operate in different ways. File systems according to examples of the disclosure can include hardware-independent functions for developers to use when writing software for ECUs.

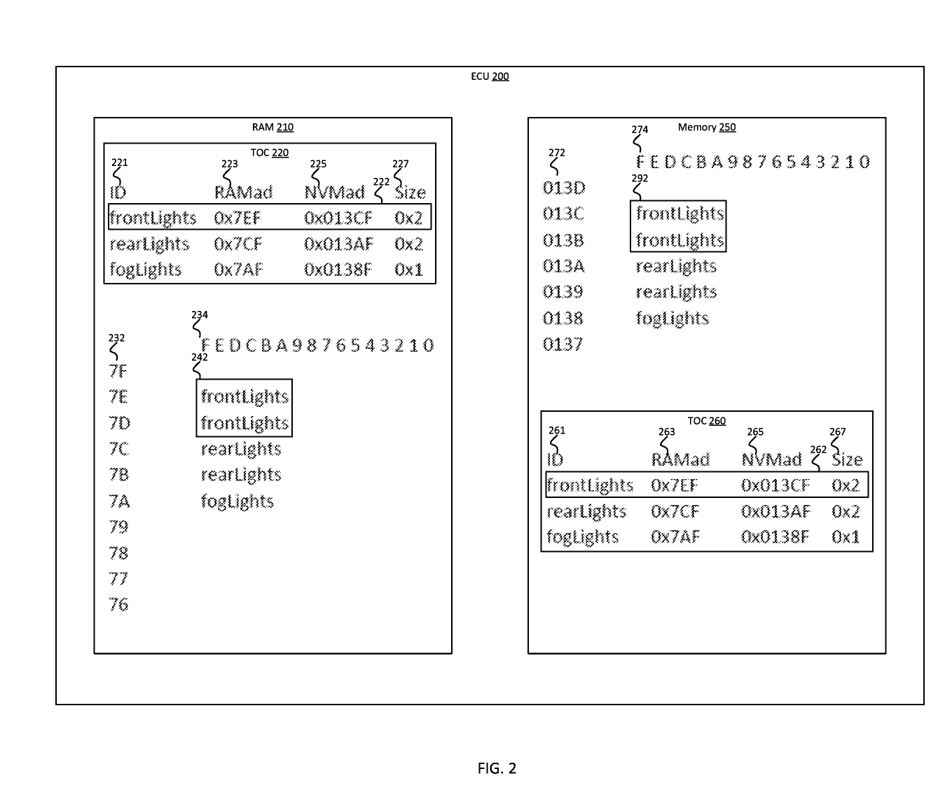

In some examples, ECUs can include RAM and non-volatile memory managed by a file system. FIG. 2 illustrates a block diagram of an exemplary ECU 200 including RAM 210 and non-volatile memory 250, each with data 242 and 292 stored thereon, according to examples of the disclosure. Data in RAM 210 can be addressed by byte number 232 and bit number 234, for example. Data in non-volatile memory 250 can be addressed by byte number 272 and bit number 274, for example. In some examples, RAM 210 can be faster and more expensive than non-volatile memory 250. Non-volatile memory 250 can retain data even when the power supply (not pictured) to the ECU 200 is disconnected, for example. Non-volatile memory 250 can be implemented with EEPROM, flash, battery-backed RAM or other types of non-volatile memory, according to examples of the disclosure. In some examples, a file system can include hardware-agnostic functions for developers to call to use the file system, making their code compatible with a variety of non-volatile memory types. Because RAM 210 and non-volatile memory 250 have different advantages and disadvantages, ECU 200 can use both levels of memory to have fast performance and inexpensive memory capable of saving data without a connected power supply.

According to some examples of the disclosure, ECU 200 can have a file system capable of managing data in RAM 210 and non-volatile memory 250. The file system can include a table of contents, of which there may be a copy 220 saved in RAM 210 and/or a copy 260 saved in non-volatile memory 250. When the table of contents 220 stored in RAM 210 is updated and then saved to non-volatile memory 250, both copies 220 and 260 can be identical. A table of contents 220 stored in RAM 210 can include entries, such as entry 222 and indicate where each data structure of the ECU is stored in RAM 210 and non-volatile memory 250, for example Likewise, for example, a table of contents 260 stored in non-volatile memory 260 of an ECU 200 can include respective entry 262.

An entry 222 to table of contents 220 can include a unique ID 221, an address 223 of the data structure in RAM 210, an address 225 of the data structure in non-volatile memory 250, and the size 227 of the data structure, for example. Likewise, for example, an entry 262 in table of contents 260 can include a unique ID 261, an address 263 of the data structure in RAM 210, an address 265 of the data structure in non-volatile memory 250, and the size 267 of the data structure. As shown in FIG. 2, for example, “frontLights” is stored at address 0x7EF in RAM 210 and address 0x013CF in non-volatile memory 250. These addresses are reflected in entry 222 in table of contents 210 and entry 262 in table of contents 260. Some example tables of contents may also include metadata (not pictured) for each entry. The metadata can include a version number and a time indicating when the entry was last saved to non-volatile memory. Some examples of the disclosure may, additionally or alternatively, have other kinds of metadata for each entry within a table of contents.

In some examples, a table of contents, such as table of contents 220 or table of contents 260 for example, can also include its own metadata (not pictured). This metadata can include an ID to indicate a location of table of contents in non-volatile memory, a version indicating the structure of the table of contents, a time indicating when the table of contents was created, and a time indicating when the table of contents was last saved to non-volatile memory. Some examples of the disclosure may, additionally or alternatively, have other kinds of metadata for a table of contents.

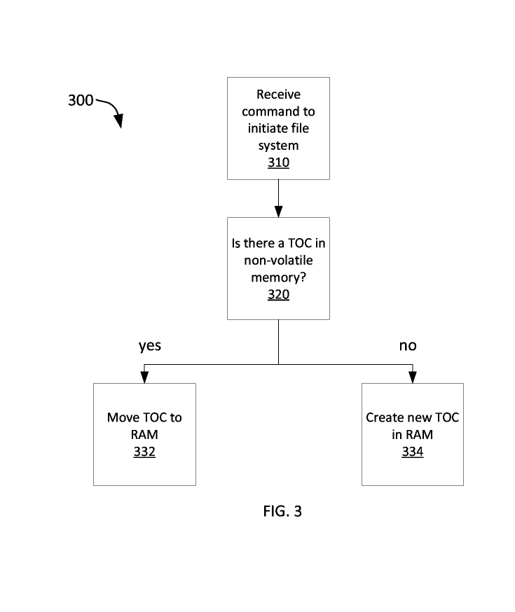

A file system according to examples of the disclosure can automatically manage where in RAM and non-volatile memory to save ECU data once it is initiated. FIG. 3 illustrates an exemplary process 300 for initiating a file system and loading 332 or generating 334 a table of contents for the file system, according to examples of the disclosure. An application stored on an ECU can execute a command to initiate a file system (e.g., the command can originate in application code). Once the command is received 310, the ECU can check 320 non-volatile memory for an existing table of contents, for example. In some examples, a table of contents and its entries may have been saved to non-volatile memory before the ECU power was disconnected. In some examples, if a table of contents is found in non-volatile memory, it can be moved 332 to RAM. In some examples, if no table of contents is found a new one can be created 334 in RAM. Once the table of contents is moved 332 to or created 334 in RAM, it can be read and edited by the ECU to manage data, according to examples of the disclosure.

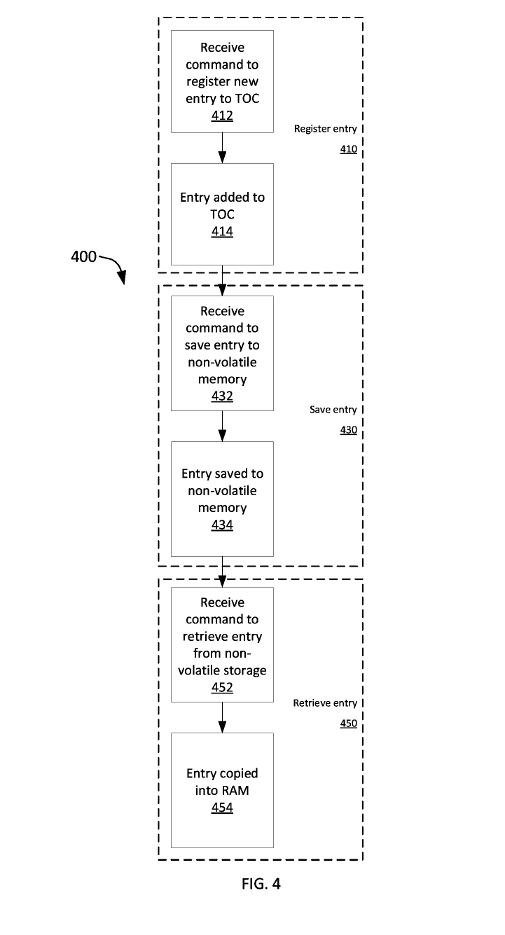

In some examples, once a table of contents is in RAM, the ECU can use the file system to manage data. FIG. 4 illustrates an exemplary process 400 for managing a data structure including registering an entry 410, saving an entry 430, and retrieving an entry 450 using a file system, according to examples of the disclosure. For data to be managed by the file system, it can be registered 410 with a table of contents, for examples. In some examples, an application executed by the ECU can include a command to register an entry. The command can include a unique ID for the entry, the size of the data structure, and a version number, for example. When the command is received 412, the entry can be added to the table of contents 414 and managed by the file system according to examples of the disclosure.

In some examples, space in RAM and non-volatile memory can be allocated for each entry at the time it is registered. In other examples, space in RAM and non-volatile memory can be dynamically allocated as needed. In some examples, when an entry is registered to the table of contents, the entry may not include an address in non-volatile memory until the application code executes a command to save it, as described below. Additionally or alternatively, in some examples, data stored in non-volatile memory may not have a RAM address associated therewith until it is loaded from non-volatile memory, as described below. Examples of saving and loading data with a file system according to examples of the disclosure will now be described.

In some examples, the file system can save 430 registered entries to non-volatile memory. Saving data to non-volatile memory, as discussed above, can have the advantages of protecting it in the event of a power outage and/or creating more space in RAM for data that needs to be edited, for example. An application executed by the ECU according to examples of the disclosure can modify data associated with a registered entry and then execute a command to save it to non-volatile memory. Once the command is received 432, the data can be saved to non-volatile memory 434, for example. In some examples, an entry may have space allocated for it in non-volatile memory when it is registered. That is, there may be space in non-volatile memory allocated for data that has not yet been saved to non-volatile memory, for example. In some examples, an entry may not have space allocated for it in non-volatile memory when it is registered. That is, an entry's address in non-volatile memory may not be included in the table of contents until the entry has been saved to non-volatile memory, for example.

In some examples, once an entry is registered 410 with the table of contents and saved 430 to non-volatile memory, it can be retrieved 450 from non-volatile memory and loaded into RAM. Loading data into RAM, as discussed above, can have the advantages of quick access and editing, for example. In some examples, an application executed by the ECU can retrieve data to be edited or otherwise used by the ECU by executing a command. Once the command is received 452, the data can be copied into RAM 454, for example. In some examples, an address in RAM may be allocated for data before a command to retrieve the entry's data is received. That is, the table of contents may already include an assigned address in RAM for an entry before it is retrieved, for example. In some examples, an address in RAM may be allocated for an entry when a command to retrieve the entry's data is received. That is, an entry's address in RAM may not be included in the table of contents until the entry has been loaded into RAM, for example. According to examples of the disclosure, an entry can be retrieved as long as it is registered to the table of contents and its data is saved to non-volatile memory. For example, if an ECU has not saved or otherwise edited data using its RAM since powering on, it can access data saved to non-volatile memory during a previous use by retrieving it from non-volatile memory.

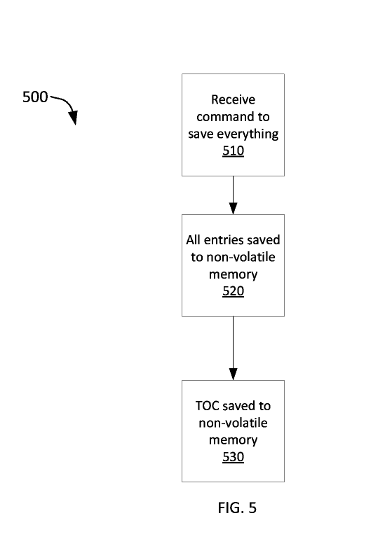

In some examples, when data is being saved to non-volatile memory, an interruption such as a power outage or other error can corrupt the data. In a safety-critical system such as an ECU, it may be important for saves only to occur when there is enough time to reliably complete the process uninterrupted, for example. Therefore, some examples of the disclosure only save data to non-volatile memory when a command to save is received from the user or when the system otherwise detects there is sufficient time to execute the save. In some examples, to preserve the table of contents and all data currently stored in RAM, everything can be saved to non-volatile memory before the power supply is disconnected. FIG. 5 illustrates an exemplary process 500 for saving all entries 520 and the table of contents 530 to non-volatile storage using a file system, according to examples of the disclosure. The system receives a command to save everything 510, for example. Then, all entries can be saved to non-volatile memory 520 and the table of contents can be saved to non-volatile memory 530, for example. In some examples, steps 520 and 530 may be performed in any order or concurrently according to various examples of the disclosure.

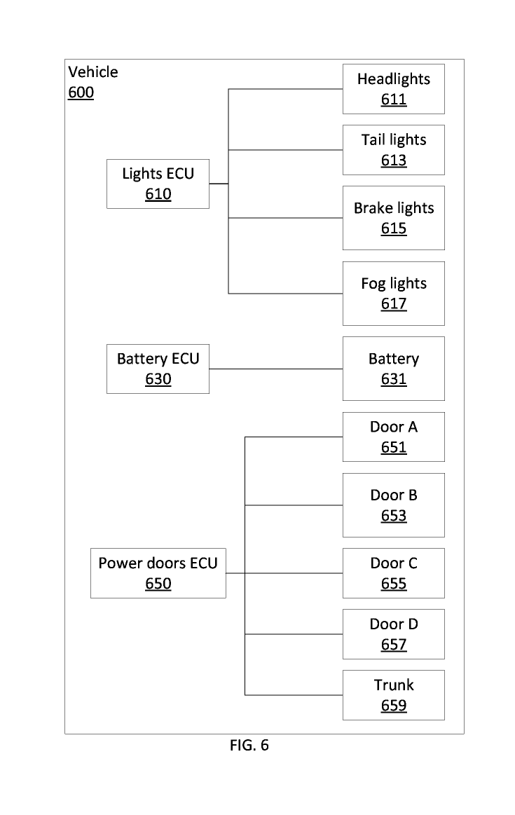

An ECU having a file system according to examples of the disclosure may be incorporated into a consumer automobile. FIG. 6 illustrates a block diagram of an exemplary vehicle 600 incorporating multiple ECUs 610, 630, and 650, according to examples of the disclosure. In some examples, each ECU can control and/or monitor an electronic system of the vehicle 600. For example, lights ECU 610 can control and/or monitor the headlights 611, tail lights 613, brake lights 615, and fog lights 617 of the vehicle 600. As another example, battery ECU 630 can control and/or monitor the battery 631 of the vehicle. As a third example, power doors ECU 650 can control door A 651, door B 653, door C 655, door D 657, and trunk 659. Other examples of the disclosure may, additionally or alternatively, include other ECUs to control other electronic systems of a vehicle.

Therefore, according to the above, some examples of the disclosure are directed to a method of managing data in an electronic control unit of a vehicle including volatile and non-volatile memory, the method comprising: at the electronic control unit of the vehicle: retrieving a table of contents from the non-volatile memory including a plurality of entries, each respective entry including a respective address in the non-volatile memory where respective data associated with the respective entry is stored; and in response to one or more requests associated with a first entry of the plurality of entries, the one or more requests originating in application code of the electronic control unit: loading first data associated with the first entry from a first address in the non-volatile memory to a second address in the volatile memory, and storing the second address in the first entry of the plurality of entries of the table of contents. Additionally or alternatively to one or more of the examples disclosed above, in some examples, the method further comprises: determining whether the table of contents is stored on the non-volatile memory; and in accordance with the table of contents not being stored on the non-volatile memory, creating the table of contents, including: in response to a plurality of entry creation requests originating in the application code of the electronic control unit, creating a respective entry in the table of contents for each of the plurality of entry requests, and assigning a respective address in non-volatile memory to the respective entry in the table of contents. Additionally or alternatively to one or more of the examples disclosed above, in some examples, the method further comprises: determining free space on the non-volatile memory; and determining an address of the free space for assigning to an entry in the table of contents. Additionally or alternatively to one or more of the examples disclosed above, in some examples, determining whether the table of contents is stored on the non-volatile memory includes determining whether a version of the table of contents is stored on the non-volatile memory in response to an initialization request that specifies the version of the table of contents, the initialization request originating in the application code of the electronic control unit. Additionally or alternatively to one or more of the examples disclosed above, in some examples, the method further comprises: in response to one or more initialization requests, originating in the application code of the electronic control unit, for each respective entry of the plurality of entries in the retrieved table of contents: loading respective data associated with the respective entry from the non-volatile memory to a respective address in the volatile memory, and storing the respective address in the respective entry of the plurality of entries of the table of contents. Additionally or alternatively to one or more of the examples disclosed above, in some examples, the method further comprises: in response to one or more shutdown requests, loading data associated with selected entries of the table of contents from the volatile memory to the non-volatile memory. Additionally or alternatively to one or more of the examples disclosed above, in some examples, the method further comprises: further in response to the one or more shutdown requests, selecting only the entries of the table of contents that have been first loaded from non-volatile memory to volatile memory to be loaded back from the volatile memory to the non-volatile memory. Additionally or alternatively to one or more of the examples disclosed above, in some examples, the method further comprises: in response to a request to load data from volatile memory to non-volatile memory, the request originating in the application code of the electronic control unit: determining a hardware type of the non-volatile memory, and writing to the non-volatile memory in accordance with the hardware type of the non-volatile memory.

Some examples of the disclosure are directed to a non-transitory computer-readable storage medium storing instructions that, when executed by one or more processors of an electronic control unit of a vehicle, causes the electronic control unit to perform a method of managing data in the electronic control unit including volatile and non-volatile memory, the method comprising: at the electronic control unit of the vehicle: retrieving a table of contents from the non-volatile memory including a plurality of entries, each respective entry including a respective address in the non-volatile memory where respective data associated with the respective entry is stored; and in response to one or more requests associated with a first entry of the plurality of entries, the one or more requests originating in application code of the electronic control unit: loading first data associated with the first entry from a first address in the non-volatile memory to a second address in the volatile memory, and storing the second address in the first entry of the plurality of entries of the table of contents. Additionally or alternatively to one or more of the examples disclosed above, in some examples, the method further comprises: determining whether the table of contents is stored on the non-volatile memory; and in accordance with the table of contents not being stored on the non-volatile memory, creating the table of contents, including: in response to a plurality of entry creation requests originating in the application code of the electronic control unit, creating a respective entry in the table of contents for each of the plurality of entry requests, and assigning a respective address in non-volatile memory to the respective entry in the table of contents. Additionally or alternatively to one or more of the examples disclosed above, in some examples, the method further comprises: determining free space on the non-volatile memory; and determining an address of the free space for assigning to an entry in the table of contents. Additionally or alternatively to one or more of the examples disclosed above, in some examples, determining whether the table of contents is stored on the non-volatile memory includes determining whether a version of the table of contents is stored on the non-volatile memory in response to an initialization request that specifies the version of the table of contents, the initialization request originating in the application code of the electronic control unit. Additionally or alternatively to one or more of the examples disclosed above, in some examples, the method further comprises: in response to one or more initialization requests, originating in the application code of the electronic control unit, for each respective entry of the plurality of entries in the retrieved table of contents: loading respective data associated with the respective entry from the non-volatile memory to a respective address in the volatile memory, and storing the respective address in the respective entry of the plurality of entries of the table of contents. Additionally or alternatively to one or more of the examples disclosed above, in some examples, the method further comprises: in response to one or more shutdown requests, loading data associated with selected entries of the table of contents from the volatile memory to the non-volatile memory. Additionally or alternatively to one or more of the examples disclosed above, in some examples, the method further comprises: further in response to the one or more shutdown requests, selecting only the entries of the table of contents that have been first loaded from non-volatile memory to volatile memory to be loaded back from the volatile memory to the non-volatile memory. Additionally or alternatively to one or more of the examples disclosed above, in some examples, the method further comprises: in response to a request to load data from volatile memory to non-volatile memory, the request originating in the application code of the electronic control unit: determining a hardware type of the non-volatile memory, and writing to the non-volatile memory in accordance with the hardware type of the non-volatile memory.

Some examples of the disclosure are directed to a method of managing data in an electronic control unit of a vehicle including volatile and non-volatile memory, the method comprising: at the electronic control unit of the vehicle: retrieving a table of contents from the non-volatile memory including a plurality of entries, each respective entry including a respective address in the non-volatile memory where respective data associated with the respective entry is stored; and in response to one or more requests associated with a first entry of the plurality of entries, the one or more requests originating in application code of the electronic control unit: loading first data associated with the first entry from a first address in the non-volatile memory to a second address in the volatile memory, and storing the second address in the first entry of the plurality of entries of the table of contents. Additionally or alternatively to one or more of the examples disclosed above, in some examples, the method further comprises: determining whether the table of contents is stored on the non-volatile memory; and in accordance with the table of contents not being stored on the non-volatile memory, creating the table of contents, including: in response to a plurality of entry creation requests originating in the application code of the electronic control unit, creating a respective entry in the table of contents for each of the plurality of entry requests, and assigning a respective address in non-volatile memory to the respective entry in the table of contents. Additionally or alternatively to one or more of the examples disclosed above, in some examples, the method further comprises: determining free space on the non-volatile memory; and determining an address of the free space for assigning to an entry in the table of contents. Additionally or alternatively to one or more of the examples disclosed above, in some examples, determining whether the table of contents is stored on the non-volatile memory includes determining whether a version of the table of contents is stored on the non-volatile memory in response to an initialization request that specifies the version of the table of contents, the initialization request originating in the application code of the electronic control unit. Additionally or alternatively to one or more of the examples disclosed above, in some examples, the method further comprises: in response to one or more initialization requests, originating in the application code of the electronic control unit, for each respective entry of the plurality of entries in the retrieved table of contents: loading respective data associated with the respective entry from the non-volatile memory to a respective address in the volatile memory, and storing the respective address in the respective entry of the plurality of entries of the table of contents. Additionally or alternatively to one or more of the examples disclosed above, in some examples, the method further comprises: in response to one or more shutdown requests, loading data associated with selected entries of the table of contents from the volatile memory to the non-volatile memory. Additionally or alternatively to one or more of the examples disclosed above, in some examples, the method further comprises: further in response to the one or more shutdown requests, selecting only the entries of the table of contents that have been first loaded from non-volatile memory to volatile memory to be loaded back from the volatile memory to the non-volatile memory. Additionally or alternatively to one or more of the examples disclosed above, in some examples, the method further comprises: in response to a request to load data from volatile memory to non-volatile memory, the request originating in the application code of the electronic control unit: determining a hardware type of the non-volatile memory, and writing to the non-volatile memory in accordance with the hardware type of the non-volatile memory.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A method of managing data in an electronic control unit of a vehicle having volatile and non-volatile memory, the method comprising the steps of:
determining whether a table of contents is stored on the non-volatile memory; and
if a table of contents is stored on the non-volatile memory:
retrieving the table of contents from the non-volatile memory including a plurality of entries, each respective entry including a respective address in the non-volatile memory at which respective data associated with the respective entry is stored;
in response to receiving one or more requests associated with a first entry of the plurality of entries,
loading first data associated with the first entry from a first address in the non-volatile memory to a second address in the volatile memory, and
storing the second address in the first entry of the plurality of entries of the table of contents, wherein the one or more requests originates from application code of the electronic control unit;
if a table of contents is not stored on the non-volatile memory:
creating the table of contents, including:
in response to a plurality of entry creation requests originating in the application code of the electronic control unit, creating a respective entry in the table of contents for each of the plurality of entry requests, and assigning a respective address in non-volatile memory to the respective entry in the table of contents.

2. (canceled)

3. The method of claim 1, the method further comprising:
determining free space on the non-volatile memory; and
determining an address of the free space for assigning to an entry in the table of contents.

4. The method of claim 1, wherein determining whether the table of contents is stored on the non-volatile memory includes determining whether a version of the table of contents is stored on the non-volatile memory in response to an initialization request that specifies the version of the table of contents, the initialization request originating in the application code of the electronic control unit.

5. The method of claim 1, the method further comprising the steps of:
in response to one or more initialization requests, originating in the application code of the electronic control unit, for each respective entry of the plurality of entries in the retrieved table of contents:
loading respective data associated with the respective entry from the non-volatile memory to a respective address in the volatile memory, and
storing the respective address in the respective entry of the plurality of entries of the table of contents.

6. The method of claim 1, the method further comprising the step of, in response to one or more shutdown requests, loading data associated with selected entries of the table of contents from the volatile memory to the non-volatile memory.

7. The method of claim 6, the method further comprising the step of, further in response to the one or more shutdown requests, selecting only the entries of the table of contents that have been first loaded from non-volatile memory to volatile memory to be loaded back from the volatile memory to the non-volatile memory.

8. The method of claim 1, the method further comprising the steps of:
in response to a request to load data from volatile memory to non-volatile memory, the request originating in the application code of the electronic control unit:
determining a hardware type of the non-volatile memory, and
writing to the non-volatile memory in accordance with the hardware type of the non-volatile memory.

9. A non-transitory computer-readable storage medium storing instructions that, when executed by one or more processors of an electronic control unit of a vehicle, causes the electronic control unit to perform a method of managing data in the electronic control unit including volatile and non-volatile memory, the method comprising the steps of:
determining whether a table of contents is stored on the non-volatile memory; and
if a table of contents is stored on the non-volatile memory:
retrieving the table of contents from the non-volatile memory including a plurality of entries, each respective entry including a respective address in the non-volatile memory at which respective data associated with the respective entry is stored; and
in response to receiving one or more requests associated with a first entry of the plurality of entries:
loading first data associated with the first entry from a first address in the non-volatile memory to a second address in the volatile memory, and
storing the second address in the first entry of the plurality of entries of the table of contents, wherein, the one or more requests originates from application code of the electronic control unit;
if a table of contents is not stored on the non-volatile memory:
creating the table of contents, including:
in response to a plurality of entry creation requests originating in the application code of the electronic control unit, creating a respective entry in the table of contents for each of the plurality of entry requests, and assigning a respective address in non-volatile memory to the respective entry in the table of contents.

10. (canceled)

11. The non-transitory computer-readable storage medium of claim 9, the method further comprising the steps of:
determining free space on the non-volatile memory; and
determining an address of the free space for assigning to an entry in the table of contents.

12. The non-transitory computer-readable storage medium of claim 9, wherein determining whether the table of contents is stored on the non-volatile memory includes determining whether a version of the table of contents is stored on the non-volatile memory in response to an initialization request that specifies the version of the table of contents, the initialization request originating in the application code of the electronic control unit.

13. The non-transitory computer-readable storage medium of claim 9, the method further comprising the steps of:
in response to one or more initialization requests, originating in the application code of the electronic control unit, for each respective entry of the plurality of entries in the retrieved table of contents:
loading respective data associated with the respective entry from the non-volatile memory to a respective address in the volatile memory, and
storing the respective address in the respective entry of the plurality of entries of the table of contents.

14. The non-transitory computer-readable storage medium of claim 9, the method further comprising the step of, in response to one or more shutdown requests, loading data associated with selected entries of the table of contents from the volatile memory to the non-volatile memory.

15. The non-transitory computer-readable storage medium of claim 14, the method further comprising the step of, further in response to the one or more shutdown requests, selecting only the entries of the table of contents that have been first loaded from non-volatile memory to volatile memory to be loaded back from the volatile memory to the non-volatile memory.

16. The non-transitory computer-readable storage medium of claim 9, the method further comprising the steps of:
in response to a request to load data from volatile memory to non-volatile memory, the request originating in the application code of the electronic control unit:
determining a hardware type of the non-volatile memory, and
writing to the non-volatile memory in accordance with the hardware type of the non-volatile memory.

17. A vehicle having:
a processor;
an electronic control unit;
a volatile memory;
a non-volatile memory; and
a non-transitory computer-readable storage medium, said medium containing executable instructions for causing the processor to perform a method of managing data in the electronic control unit, the method comprising the steps of:
determining whether a table of contents is stored on the non-volatile memory; and
if a table of contents is stored on the non-volatile memory:
retrieving a table of contents from the non-volatile memory including a plurality of entries, each respective entry including a respective address in the non-volatile memory at which respective data associated with the respective entry is stored; and
in response to one or more requests associated with a first entry of the plurality of entries, the one or more requests originating in application code of the electronic control unit:
loading first data associated with the first entry from a first address in the non-volatile memory to a second address in the volatile memory, and
storing the second address in the first entry of the plurality of entries of the table of contents;
if a table of contents is not stored on the non-volatile memory:
creating the table of contents, including:
in response to a plurality of entry creation requests originating in the application code of the electronic control unit, creating a respective entry in the table of contents for each of the plurality of entry requests, and assigning a respective address in non-volatile memory to the respective entry in the table of contents.

18. (canceled)

19. The vehicle of claim 17, said method further comprising the steps of:
determining free space on the non-volatile memory; and
determining an address of the free space for assigning to an entry in the table of contents.

20. The vehicle of claim 17, wherein determining whether the table of contents is stored on the non-volatile memory includes determining whether a version of the table of contents is stored on the non-volatile memory in response to an initialization request that specifies the version of the table of contents, the initialization request originating in the application code of the electronic control unit.

21. The vehicle of claim 17, said method further comprising the steps of:
in response to one or more initialization requests, originating in the application code of the electronic control unit, for each respective entry of the plurality of entries in the retrieved table of contents:
loading respective data associated with the respective entry from the non-volatile memory to a respective address in the volatile memory, and
storing the respective address in the respective entry of the plurality of entries of the table of contents.

22. The vehicle of claim 17, said method further comprising the step of, in response to one or more shutdown requests, loading data associated with selected entries of the table of contents from the volatile memory to the non-volatile memory.

23. The vehicle of claim 22, said method further comprising the step of, further in response to the one or more shutdown requests, selecting only the entries of the table of contents that have been first loaded from non-volatile memory to volatile memory to be loaded back from the volatile memory to the non-volatile memory.

24. (canceled)
